(19) United States
(12) Patent Application Publication
(10) Pub. No.: US 2022/0396103 A1
(43) Pub. Date: Dec. 15, 2022

(54) PNEUMATIC VEHICLE TIRE HAVING A RIM PROTECTION RIB

(71) Applicant: Continental Reifen Deutschland GmbH, Hannover (DE)

(72) Inventors: Jörg Arensmeier, Hannover (DE); Christian Marschler, Hildesheim (DE); Marcel Neumann, Hannover (DE); Matthias Plückers, Barsinghausen (DE); Stefan Rittweger, Garbsen (DE); Florian Wiegmann, Seelze (DE)

(73) Assignee: Continental Reifen Deutschland GmbH, Hannover (DE)

(21) Appl. No.: 17/755,213

(22) PCT Filed: Oct. 12, 2020
(86) PCT No.: PCT/EP2020/078555

§ 371 Date: Apr. 22, 2022

(30) Foreign Application Priority Data
Nov. 4, 2019 (DE) 10 2019 216 915.5

(51) Int. Cl. B60C 15/024; B60C 3/04

(52) U.S. Cl. CPC B60C 15/0242; B60C 3/04; B60C 2200/04

(57) ABSTRACT

A pneumatic vehicle tire having a rim protection rib (9), wherein the design of the rim protection rib has the object of having a pneumatic vehicle tire with improved durability, and scaling of the axial width of the rim protection rib is intended to permit only minor effects on the rolling resistance and the durability; this is achieved in that, as viewed in the tire cross section, an axially outer contour (10) of the rim protection rib (9) begins radially on the outside with a convexly curved first region (12) which tangentially adjoins an axially outer contour (11) of the sidewall (6), in that the first region (12) merges radially inward tangentially into a concavely curved second region (13), in that the second region (13) merges tangentially into a convexly curved third region (15), and in that the third region (15) merges tangentially into a fourth region (16) encompassing the axially outermost point (17) of the rim protection rib (9).

The invention relates to a pneumatic vehicle tire having a tread, two sidewalls and two bead regions, wherein axially on the outside at least on one tire sidewall at the level of the bead region there is a rim protection rib running around the circumference of the tire sidewall, wherein, as viewed in the tire cross section, an axially outer contour of the rim protection rib has a concave curvature.

Rim protection ribs on pneumatic vehicle tires are known in the prior art. The rim protection rib is usually a wedge made of rubber, which is connected integrally to the sidewall and runs around the sidewall in a closed ring over the circumference of said sidewall. The rim protection rib, if placed on the outer surface of the sidewall, protrudes axially outward from the sidewall as a wedge. The rim protection rib is arranged at a tire cross-sectional height at least on the lower sidewall approximately at the level of the bead region in such a way that, when a tire is pulled onto the wheel, said rim protection rib runs directly above the rim flange and extends axially at least to the same extent as the rim flange or axially beyond the rim flange in order to protect the rim flange and the rim from lateral scuffing contacts, such as contacts with curbs, by the rim protection rib absorbing said contacts.

Rim protection ribs which are placed onto the sidewall in a concave radius are known. However, when rim protection ribs are “placed on” with only a concave radius, it has been shown that the rigidity in the radial direction is too low. In addition, the geometry of such a rim protection rib is unfavorable for the production of a negative mold of the sidewall region of the tire for a shaping vulcanization mold, since labeling has to be applied by milling even to the axially widest point of the rim protection rib. There is then insufficient space here for the movement travel of a milling tool.

For this purpose, DE 102008028780 A1 proposes that the contour of the rim protection rib is only convex and/or rectilinear from an upper end of the sidewall to the lower end of the rim protection rib, as a result of which the thickness of the overall construction increases to a greater extent radially inward. A disadvantage of this is that the sidewall is stiffened at the level of the tire equator and is therefore less flexible. This uneven distribution of the rigidity of the rim protection rib in the radial direction results in stress peaks in the upper region of the sidewall. This can reduce the durability of the tire. In addition, such a construction is associated with an additional outlay in terms of material and a material distribution that is unfavorable for the spring deflection. Scaling of the axial width of the rim protection rib also leads to a sharp increase in the amount of material used and thus in the rolling resistance.

It is therefore the object of the present invention to provide a pneumatic vehicle tire which has improved durability and which enables scaling of the axial width of the rim protection rib with only minor effects on the rolling resistance and the durability.

The object is achieved in that, as viewed in the tire cross section, the axially outer contour of the rim protection rib begins radially on the outside with a convexly curved first region which tangentially adjoins an axially outer contour of the sidewall and differs in its curvature from a curvature of the sidewall adjoining the rim protection rib radially on the outside, in that the first region merges radially inward tangentially into a concavely curved second region, in that the second region merges tangentially into a convexly curved third region, and in that the third region merges tangentially into a fourth region encompassing the axially outermost point of the rim protection rib.

It is essential for the invention that the axially outer contour of the rim protection rib has a sequence of differently curved regions. This results in an S twist in the outer contour radially outside the widest point of the rim protection rib.

The convexly curved first region makes it possible to regulate the extent of the rim protection rib radially outward.

The concavely curved second region enables a more uniform material distribution in the radial direction, in particular radially outside the tire equator. On the one hand, this leads to less material being used, which is advantageous for the rolling resistance, compared to a rim protection rib without a concave curvature as is known from the prior art. On the other hand, a more uniform material distribution of the rim protection rib in the radial direction leads to a more uniform rigidity distribution of the sidewall, in particular radially outside the tire equator, which in turn leads to a more uniform deformation of the sidewall during spring deflection. This can further improve the endurance limit of the tire.

The third region having a convex curvature furthermore permits an advantageous radial thickness of the rim protection rib radially within the tire equator, despite the concavely curved second region, with simultaneously limited axial width up to the axially outermost region of the rim protection rib within the fourth region. The radial rigidity thereby made possible radially inside the tire equator permits the rim protection rib to have an advantageous protective effect in relation to the rim flange.

Thus, not only is material reduced, but an improved distribution of the rigidity of the rib in the radial direction is also made possible, as a result of which the shear and stress profile, in particular radially outside the tire equator, is improved. This results in an advantageous spring deflection behavior. At the same time, this reduces the risk of crack formation or fractures, which improves the durability of the tire.

A further advantage is afforded by the fact that only small changes in the amount of material and the material distribution of the rim protection rib radially outside the tire equator are necessary because of the S twist with a scaling of the axial width of the rim protection rib. As a result, the effect of scaling of the axial width of the rim protection rib on the rolling resistance and the durability is small.

Another advantage of the S twist is that, when producing a negative mold of the sidewall region of the tire for a shaping vulcanization mold, there is also sufficient space in the third and fourth regions for the movement travel of a milling tool. This also makes the third and fourth regions available for labeling.

The four regions in each case merge into one another tangentially, as a result of which an axially outer contour of the rim protection rib free of kinks is made possible. Such a smooth transition between the regions of differing curvature behavior avoids stress peaks and has advantageous aerodynamics.

The description of the tire according to the invention is based on the vulcanized tire which is not pulled onto the rim. The cross-sectional height of the pneumatic vehicle tire is measured from the outer tread surface as far as the cross-sectional height of the nominal rim diameter. The tire equator runs here perpendicular to the radial direction at half the cross-sectional height of the tire.

The rim protection rib is completely or at least partially part of the sidewall. The designation of the curvature as concavely or convexly curved refers to a viewing direction of the tire surface from axially on the outside.

An advantageous embodiment is provided by the fact that, as viewed in the tire cross section radially inward from radially on the outside, the thickness of the sidewall is substantially constant over a height extent of at least ⅓ of the height of the sidewall radially outside the tire equator and is 2 mm to 5 mm, in particular approximately 3 mm.

Owing to the small variation in thickness of the sidewall radially outside the tire equator, an even more uniform distribution of the rigidity is achieved, which leads to a more uniform deformation of the tire during spring deflection. Improved durability can thus be achieved because of the lower material stress.

The height of the sidewall radially outside the equator is measured here from the tire equator as far as the radially innermost end of a breaker belt assembly made of belt plies and a bandage. The thickness of the sidewall is measured axially outside the carcass, perpendicular to the carcass.

A further advantageous embodiment is provided by the fact that the height of the rim protection rib is 14 mm to 21 mm, preferably 17 mm to 21 mm, particularly preferably 19 mm to 21 mm, wherein the height is measured radially outward from the axially outermost point of the rim protection rib, and that the rim protection rib has a height extent of 0 mm to a maximum of 8 mm radially outside the tire equator.

Both the height of the rim protection rib is limited and the region of the tire thickened by the rim protection rib is limited radially outward, which enables an advantageous distribution of rigidity of the tire in the sidewall region and less use of materials. Depending on the tire size, the rim protection rib can also be arranged completely radially inside the tire equator and can thus have a vertical extent of 0 mm radially outside the tire equator.

An advantageous embodiment is also provided by the fact that the first region adjoins the second region at a first turning point, the first turning point being arranged at a radial distance from the axially outermost point of the rim protection rib of 10 mm to 17 mm, and that the second region adjoins the third region at a second turning point, the second turning point being arranged at a radial distance from the axially outermost point of the rim protection rib of 4 mm to 6 mm.

Such radial dimensions of the contour have been shown to be particularly advantageous for durability properties and the scalability of the rim protection rib.

It is also advantageous if the first region is designed as a circular arc, preferably as a circular arc with a radius R1 of 40 mm to 200 mm.

Such a convexly curved transition circular arc from the sidewall contour to the rim protection rib contour has been found to be advantageous for regulating and limiting the extent of the rim protection rib radially outward. It is particularly advantageous if the circular arc has the radius R1. The circular arc merges radially outward, preferably tangentially, into the contour of the sidewall.

An advantageous embodiment is provided by the fact that the second region is designed as a circular arc with a radius R2 of 30 mm to 40 mm, preferably of 34 mm to 36 mm.

Such a concavely curved circular arc with a radius R2 enables a particularly advantageous material distribution and a particularly advantageous radial rigidity distribution.

A further advantageous embodiment is provided by the fact that the third region is designed as a circular arc with a radius R3 of 8 mm to 12 mm, preferably of approximately 10 mm.

A particularly advantageous transition to the fourth region having the axially outermost point is provided by such a convexly curved circular arc with a radius R3. As a result, a radial rigidity that is advantageous for the protective effect of the rim protection rib is made possible radially inside the tire equator. At the same time, when producing a corresponding negative mold for the tire construction process, there is sufficient space for the movement travel of a milling tool, such that the axially outer surface of the tire is also available radially within the third region for labeling.

An advantageous embodiment is also provided by the fact that the fourth region is delimited radially inward from the axially outermost point and has a height of 1.8 mm to 3 mm, preferably of approximately 2 mm.

When producing a corresponding negative mold for the tire construction process, such an arrangement, in particular because of the sufficient height of the fourth region, provides sufficient space for the movement travel of a milling tool. Thus, the axially outer surface of the tire is also still available radially within the third region for labeling.

An advantageous embodiment is provided by the fact that a radial tire for a passenger car, preferably with a height-to-width ratio of 25% to 65%, is involved.

The use of rim protection ribs in the type of tire mentioned is particularly advantageous since these tires on the market often come into contact with curbs or similar obstacles, for example, and the rims have to be protected accordingly. However, the invention is also suitable for other pneumatic vehicle tires having a rim protection rib.

Further features, advantages and details of the invention will be discussed in more detail on the basis of the drawings, which illustrate schematic exemplary embodiments. In the drawings

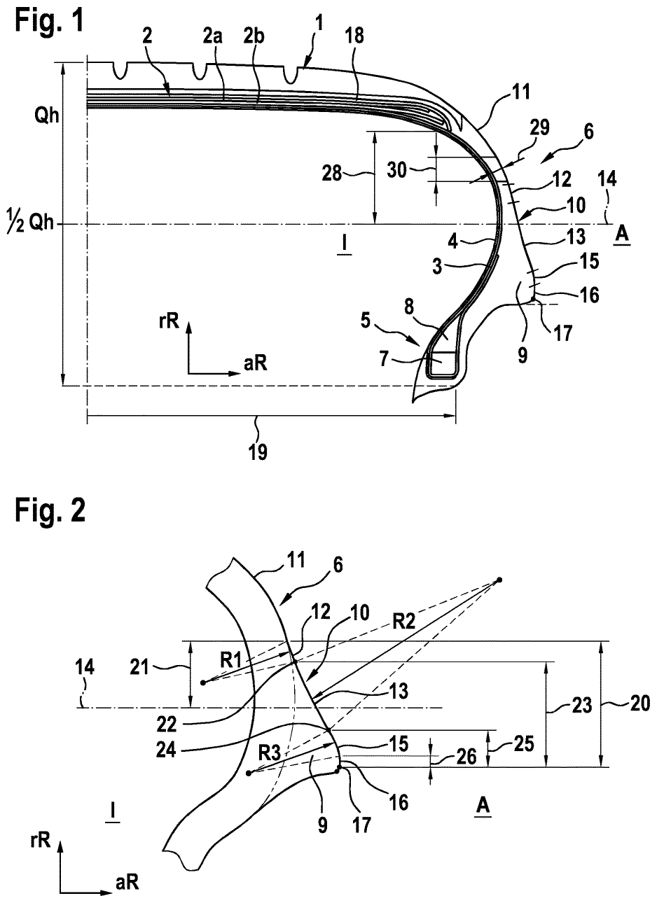

FIG. 1 shows a partial cross section of the pneumatic vehicle tire according to the invention;

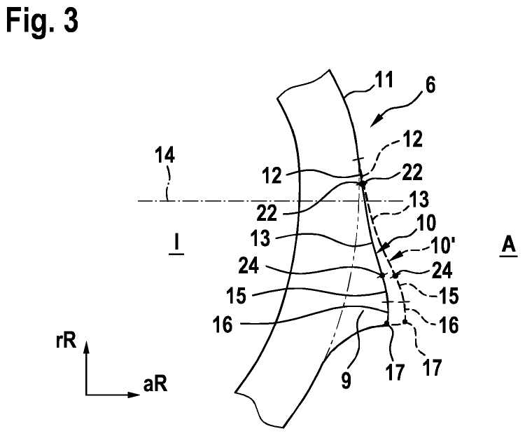

FIGS. 2 and 3 each show an enlargement of a partial cross section of a pneumatic vehicle tire according to the invention.

FIG. 1 shows a partial cross section through a radial tire for passenger cars, which has a profiled tread 1, a belt 2 consisting of two plies 2a, 2b, which is covered by a bandage 18, a radial carcass 3, an airtight inner layer 4, sidewalls 6 and bead regions 5 with bead cores 7 and core profiles 8. A rim protection rib 9 running around the circumference of the tire sidewall 6 is arranged axially on the outside A at least on one tire sidewall 6 above the bead region 5. The rim protection rib 9 is completely or partially part of the sidewall 6.

As viewed in the tire cross section, an axially outer contour 10 of the rim protection rib 9 begins radially on the outside with a convexly curved first region 12 which tangentially adjoins an axially outer contour 11 of the sidewall 6 and differs in its curvature from a curvature of the sidewall 6 adjoining the rim protection rib 9 radially on the outside.

The first region 12 merges radially inward tangentially into a concavely curved second region 13. The second region 13 merges tangentially into a convexly curved third region 15. The third region 15 merges tangentially into a fourth region 16 encompassing the axially outermost point 17 of the rim protection rib 9.

The four regions 12, 13, 15, 16 in each case merge into one another tangentially, as a result of which an axially outer contour of the rim protection rib free of kinks is made possible. The cross-sectional height Qh of the pneumatic vehicle tire is measured from the outer tread surface to the cross-sectional height of the nominal rim diameter at which the nominal rim width 19 is measured.

The tire equator 14 runs perpendicular to the radial direction rR at half the cross-sectional height ½ Qh of the tire. The rim protection rib 9 is completely or at least partially part of the sidewall 6. The designation of the curvature as concavely or convexly curved refers to a viewing direction of the tire surface from axially on the outside.

A radial tire for a passenger car, preferably with a height-to-width ratio of 25% to 65%, can be involved.

The thickness 29 of the sidewall 6 can be substantially constant over a height extent 30 of at least ⅓ of the height 28 of the sidewall radially outside the tire equator 14 and can be 2 mm to 5 mm, in particular approximately 3 mm, here. The height 28 of the sidewall radially outside the equator 14 is measured here from the tire equator 14 as far as the radially innermost end of a breaker belt assembly made of belt plies 2a, 2b and a bandage 18. The thickness 29 of the sidewall is measured axially outside the carcass 3 perpendicular to the carcass 3.

FIG. 2 illustrates an enlargement of a partial cross section of an exemplary embodiment of a pneumatic vehicle tire according to the invention at least in the region of the rim protection rib 9. For the sake of clarity, only the contour of the tire is illustrated. It can be the pneumatic vehicle tire illustrated in FIG. 1.

The height 20 of the rim protection rib 9 is 14 mm to 21 mm, preferably 17 mm to 21 mm, particularly preferably 19 mm to 21 mm, the height 20 being measured radially outward from the axially outermost point 17 of the rim protection rib. At the same time, the rim protection rib 9 radially outside of the tire equator 14 has a height extent 21 of 0 mm to a maximum of 8 mm.

The first region 12 adjoins the second region 13 at a first turning point 22, the first turning point 22 being arranged at a radial distance 23 from the axially outermost point 17 of the rim protection rib of 10 mm to 17 mm. At the same time, the second region 13 adjoins the third region 15 at a second turning point 24, the second turning point 24 being arranged at a radial distance 25 from the axially outermost point 17 of the rim protection rib of 4 mm to 6 mm.

The first region 12 is designed as a circular arc, preferably as a circular arc with a radius R1 of 40 mm to 200 mm. The segment of a circle belonging to the circular arc is illustrated by dashed lines. The second region 13 is designed as a circular arc with a radius R2 of 30 mm to 40 mm, preferably of 34 mm to 36 mm. The third region 15 is designed as a circular arc with a radius R3 of 8 mm to 12 mm, preferably of approximately 10 mm.

The fourth region 16 is delimited radially inward from the axially outermost point 17 and has a height 26 here of 1.8 mm to 3 mm, preferably of approximately 2 mm.

FIG. 3 illustrates the advantageous scalability of the rim protection rib 9 that is made possible by the S twist. A detail of the axially outer contour 10, 11 of a pneumatic vehicle tire is shown. It can be the axially outer contour of the detail shown in FIG. 2. The dashed line shows an axially outer contour 10′, 11 for scaling of the rim protection rib 9 axially outward. Such a scaling is possible without the axially outer contour 11 of the sidewall 6 having to be changed radially outside of the rim protection rib 9.

### LIST OF REFERENCE SIGNS

### (Part of the Description)

1 Tread
2 Belt
3 Carcass
4 Inner layer
5 Bead region
6 Sidewall
7 Bead core
8 Bead filler
9 Rim protection rib
10 Axially outer contour of the rim protection rib
11 Axially outer contour of the sidewall
12 First region
13 Second region
14 Tire equator
15 Third region
16 Fourth region
17 Axially outermost point of the rim protection rib
18 Belt bandage
19 Nominal rim width
20 Height
21 Height extent
22 First turning point
23 Radial distance
24 Second turning point
25 Radial distance
26 Height
28 Height
29 Thickness
30 Height extent
Qh Cross-sectional height of the tire
rR Radial direction
aR Axial direction
A Axially on the outside
I Axially on the inside

1-9. (canceled)

10. A pneumatic vehicle tire having a tread (1), two sidewalls (6) and two bead regions (5), wherein axially on an outside (A) at least on one tire sidewall of the two tire sidewalls (6) at a level of one bead region of the two bead regions (5) there is a rim protection rib (9) running around a circumference of the one tire sidewall, wherein, as viewed in a tire cross section, an axially outer contour (10, 10′) of the rim protection rib (9) has a concave curvature;
wherein as viewed in the tire cross section, the axially outer contour (10, 10′) of the rim protection rib (9):
begins radially on the outside with a convexly curved first region (12) which tangentially adjoins an axially outer contour (11) of the one tire sidewall (6) and differs in its curvature from a curvature of the one tire sidewall (6) adjoining the rim protection rib (9) radially on the outside,
in that the first region (12) merges radially inward tangentially into a concavely curved second region (13),
in that the second region (13) merges tangentially into a convexly curved third region (15),
and in that the third region (15) merges tangentially into a fourth region (16) encompassing an axially outermost point (17) of the rim protection rib (9).

11. The pneumatic vehicle tire as claimed in claim 10, wherein, as viewed in the tire cross section radially inward from radially on the outside, a thickness (29) of the one sidewall (6) is substantially constant over a height extent (30) of at least ⅓ of the height (28) of the sidewall radially outside a tire equator (14) and is from 2 mm to 5 mm.

12. The pneumatic vehicle tire as claimed in claim 11, wherein the thickness (29) of the one sidewall is 3 mm.

13. The pneumatic vehicle tire as claimed in claim 10, wherein height (20) of the rim protection rib (9) is from 14 mm to 21 mm, wherein the height (20) is measured radially outward from the axially outermost point (17) of the rim protection rib, and wherein the rim protection rib (9) has a height extent (21) of from 0 mm to a maximum of 8 mm radially outside the tire equator (14).

14. The pneumatic vehicle tire as claimed in claim 10, wherein the first region (12) adjoins the second region (13) at a first turning point (22), the first turning point (22) being arranged at a radial distance (23) from the axially outermost point (17) of the rim protection rib of from 10 mm to 17 mm, and in that the second region (13) adjoins the third region (15) at a second turning point (24), the second turning point (24) being arranged at a radial distance (25) from the axially outermost point (17) of the rim protection rib of from 4 mm to 6 mm.

15. The pneumatic vehicle tire as claimed in claim 10, wherein the first region (12) is designed as a circular arc with a first radius (R1) of from 40 mm to 200 mm.

16. The pneumatic vehicle tire as claimed in claim 10, wherein the second region (13) is designed as a circular arc with a second radius (R2) of from 30 mm to 40 mm.

17. The pneumatic vehicle tire as claimed in claim 10, wherein the third region (15) is designed as a circular arc with a third radius (R3) of from 8 mm to 12 mm.

18. The pneumatic vehicle tire as claimed in claim 10, wherein the fourth region (16) is delimited radially inward from the axially outermost point (17) and has a height (26) of from 1.8 mm to 3 mm.

19. The pneumatic vehicle tire as claimed in claim 10, wherein the pneumatic vehicle tire is a radial tire for a passenger car with a height-to-width ratio of from 25% to 65%.

20. A pneumatic vehicle tire having a tread (1), two sidewalls (6) and two bead regions (5), wherein axially on an outside (A) at least on one tire sidewall of the two tire sidewalls (6) above one bead region of the two bead regions (5) there is a rim protection rib (9) running around a circumference of the one tire sidewall, wherein, as viewed in a tire cross section, an axially outer contour (10, 10′) of the rim protection rib (9) has a concave curvature;
wherein as viewed in the tire cross section, the axially outer contour (10, 10′) of the rim protection rib (9):
begins radially on the outside with a convexly curved first region (12) which tangentially adjoins an axially outer contour (11) of the one tire sidewall (6) and differs in its curvature from a curvature of the one tire sidewall (6) adjoining the rim protection rib (9) radially on the outside,
in that the first region (12) merges radially inward tangentially into a concavely curved second region (13),
in that the second region (13) merges tangentially into a convexly curved third region (15),
and in that the third region (15) merges tangentially into a fourth region (16) encompassing an axially outermost point (17) of the rim protection rib (9).

21. The pneumatic vehicle tire as claimed in claim 20, wherein, as viewed in the tire cross section radially inward from radially on the outside, a thickness (29) of the one sidewall (6) is substantially constant over a height extent (30) of at least ⅓ of the height (28) of the sidewall radially outside a tire equator (14) and is from 2 mm to 5 mm.

22. The pneumatic vehicle tire as claimed in claim 21, wherein the thickness (29) of the one sidewall is 3 mm.

23. The pneumatic vehicle tire as claimed in claim 20, wherein height (20) of the rim protection rib (9) is from 14 mm to 21 mm, wherein the height (20) is measured radially outward from the axially outermost point (17) of the rim protection rib, and wherein the rim protection rib (9) has a height extent (21) of from 0 mm to a maximum of 8 mm radially outside the tire equator (14).

24. The pneumatic vehicle tire as claimed in claim 20, wherein the first region (12) adjoins the second region (13) at a first turning point (22), the first turning point (22) being arranged at a radial distance (23) from the axially outermost point (17) of the rim protection rib of from 10 mm to 17 mm, and in that the second region (13) adjoins the third region (15) at a second turning point (24), the second turning point (24) being arranged at a radial distance (25) from the axially outermost point (17) of the rim protection rib of from 4 mm to 6 mm.

25. The pneumatic vehicle tire as claimed in claim 20, wherein the first region (12) is designed as a circular arc with a first radius (R1) of from 40 mm to 200 mm.

26. The pneumatic vehicle tire as claimed in claim 20, wherein the second region (13) is designed as a circular arc with a second radius (R2) of from 30 mm to 40 mm.

27. The pneumatic vehicle tire as claimed in claim 20, wherein the third region (15) is designed as a circular arc with a third radius (R3) of from 8 mm to 12 mm.

28. The pneumatic vehicle tire as claimed in claim 20, wherein the fourth region (16) is delimited radially inward from the axially outermost point (17) and has a height (26) of from 1.8 mm to 3 mm.

29. The pneumatic vehicle tire as claimed in claim 20, wherein the pneumatic vehicle tire is a radial tire for a passenger car with a height-to-width ratio of from 25% to 65%.
